(19) United States
(12) Patent Application Publication
(10) Pub. No.: US 2006/0013141 A1
(43) Pub. Date: Jan. 19, 2006

(54) Loop frame detecting device and method for detecting loop frame

(75) Inventors: Ryoichi Mutoh, Kawasaki (JP); Tetsuya Nishi, Kawasaki (JP); Kiichi Sugitani, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/024,519

(22) Filed: Dec. 29, 2004

(30) Foreign Application Priority Data
Jul. 14, 2004 (JP) 2004-207517

(51) Int. Cl. G01R 31/08; H04L 12/28

(52) U.S. Cl. 370/241; 370/389

(57) ABSTRACT

A loop frame detecting devise includes a frame receiving and transmitting unit and a loop detecting unit. The frame receiving and transmitting unit receives and transmits the Layer 2 frame. The loop detecting unit monitors contents of the frame that is received or to be transmitted by the frame receiving and transmitting unit, determines whether the frame is a loop frame that circulates in the Layer 2 network, detects the loop frame, and minimizes a loop failure.

### CROSS-REFERENCE TO RELATED APPLICATIONS

This application is based upon and claims the benefit of priority from the prior Japanese Patent Application No.2004-207517, filed on Jul. 14, 2004, the entire contents of which are incorporated herein by reference.

### BACKGROUND OF THE INVENTION

1) Field of the Invention

The present invention relates to a technology for detecting a failure in a network, and preventing the failure or spreading of the failure.

2) Description of the Related Art

Ethernet® is a typical configuration scheme of a LAN and falls into the second layer (hereinafter, “Layer 2” or “Data Link Layer”) network in the Open Systems Interconnection (OSI) reference model. The Institute of Electrical and Electronics Engineers (IEEE) defines the IEEE 802.3 standard as a standard specification for the network, and the information and telecommunications networks are widely used that comply with the standard or the extended standard of the standard (i.e. Layer 2 network).

Each node in the Layer 2 network monitors a frame transmitted on cable, and accepts the frame when the destination MAC address of the frame matches its own MAC address or the broadcast address. Generally speaking, there are a hub and a bridge (i.e. L2 switch) as an intermediary device in the Layer 2 network that connects the nodes to each other.

FIG. 20 is a schematic for explaining the operation of an ordinary hub 201. The hub 201 transmits a frame received from a terminal 202 to all terminals, other than the terminal 202, that are connected to the hub 201. Namely, the hub 201 transmits the frame to the terminals 203, 204, and 205. All ports other than a receiving port 201a of the frame, namely the ports 201b to 201d, transmit the frame. Each of the terminals 203 to 205 determines whether to accept the frame or not.

FIG. 21 is a schematic for explaining the operation of an ordinary bridge 211. The bridge 211 specifies the destination MAC address by parsing the frame from the terminal 202, and transmits the frame only to the terminal that corresponds to the specified MAC address (i.e., the terminal 204). More specifically, the bridge 211 searches a Filtering Data Base (FDB) based on the destination MAC address of the received frame, and determines the port to be forwarded the frame (i.e., a port 211c). On the other hand, the bridge 211 registers in the FDB the destination MAC address and a receiving port 211a of the received frame.

Thus, the bridge 211 learns which one of the ports 211b to 211d should be used to transmit the frame received on the port 211a. Accordingly, the bridge 211 can reduce the load of the entire network, and enhance the security of the network.

In the event that the destination MAC address of the frame to be forwarded is the broadcast address or the MAC address that is not in the FDB, the bridge 211 functions like the hub 201 shown in FIG. 20. More specifically, the bridge 211 duplicates the frame as much as needed and transmits the frames on all ports other than the receiving port 211a, namely the ports 211b to 211d (hereinafter, “flooding”).

A network is made up of the intermediary devices such as the hub 201 and the bridge 211, and the terminals 202 to 205 explained above. The network should not be the loop topology network because the Layer 2 device basically assumes star topology or tree topology as the network topology. On the other hand, for the purpose of such as the enhancement of the availability, it is often required to secure the redundancy of the intermediary device or the communication pathway, which causes inevitably a loop in the frame transmission. As a mechanism to prevent the loop, the Spanning Tree Protocol (STP) standardized as the IEEE 802.1d has been suggested.

In the STP, the bridges determine the root bridge based on the bridge priority set in the Bridge Protocol Data Unit (BPDU) packet, which is exchanged among the bridges, and a tree topology network called “spanning tree” is built. In the network, the frame can reach all bridges but there is only one pathway for each destination. A blocking port is arranged in an unused link to block the traffic of the frame. When a failure occurs, the spanning tree is rebuilt and the blocking port is automatically opened to recover from the failure.

Furthermore, in the IEEE 802.1w, the Rapid STP is provided that can perform the switching process more quickly when the failure occurs. In the IEEE 802.1s, the Multiple STP is provided that can deal with a plurality of topologies (instance) of the STP.

The penetration rate of the Layer 2 network is rapidly increasing due to the price-reduction of the device (such as the bridge and the switching hub) that constitutes the Layer 2 network, the acceleration of communication, and especially the easiness of installation of the device achieved by such functions as “Auto Negotiation” (i.e. function for automatic recognition of the communication speed or the types of full-duplex/half-duplex) and “AUTO-MDIX” (i.e. function for automatic distinction between a cross cable and a straight cable).

The diffusion of the hub and the bridge with the AUTO-MDIX function improved usability, in the fact that the user need not care about which cable should be inserted to which port. However, the easiness induces incorrect connection, and consequently the network loop caused by incorrect connection. For example, the failure is frequently caused by the non-intelligent hub that is commonly used at the end of the network. However, in many cases the hub is not implemented any protocol for preventing the loop, such as STP. Furthermore, in many cases a monitoring device in the network cannot even recognize the non-intelligent hub, because the hub cannot be externally accessed using telnet, Simple Network Management Protocol (SNMP), or the like. Thus, the detection and the prevention of the failure are difficult. Furthermore, even if the STP for preventing the loop is running on the hub, the network loop is also formed due to a failure occurred in the control system of the bridge, malfunction of the STP that failed to receive the BPDU packet, and so on.

When the loop failure occurs in the Layer 2 network, the broadcast storm caused by the flooding becomes problematic. The broadcast storm means that the broadcast frame or the frame with unknown destination address is kept to be transferred and duplicated semipermanently, without being discarded, and saturates the network bandwidth. The frame circulating in the loop is duplicated every time the frame goes thorough the bridge or the hub. The duplicated frame is transmitted all over the network to saturate the bandwidth even in the links that do not constitute the loop. The broadcast storm causes network congestion and leads to a massive failure, such as network down, due to considerable communication delay, overload of the intermediary device, or the like.

When the loop failure occurs, system administrators deal with the failure by hand in many cases. The procedure is as follows; cut the link that constitutes the loop, or stop the frame transmission by the switch in the loop; flush the contents of the FDB. In practice, however, it is difficult and takes quite a lot of man-hours to identify which link constitutes the loop.

As the conventional art that solves the problem of the loop failure in the Layer 2 network, there is a bridge that has the function of such as limiting the traffic of the broadcast frame, and monitoring the source address and the receiving port of the frame. Such a conventional bridge is disclosed in Japanese Patent Laid-Open Publication No. H9-93282. FIG. 22 is a schematic of the conventional bridge that detects the loop when receiving frames with an identical source address on different ports. A personal computer 222 transmits a frame 225 to a loop network that includes a plurality of bridges 221a to 221d. A processing unit 223 in the bridge 221a registers the source address and the receiving port of the received frame, and compares the source address of a newly received frame to the index of a database (DB) 224. When receiving frames with an identical source address on different ports, the processing unit 223 determines that the loop has been formed.

FIG. 23 is a schematic of the conventional frame transfer device. A personal computer 232 transmits a frame 235 to a loop network that includes a plurality of frame transfer devices 231a to 231d. The frame transfer device 231a identifies the loop frame by monitoring the IP header (for example, see the Japanese Patent Laid-Open Publication No. 2001-197114). As for a ring network such as Fiber-Distributed Data Interface (FDDI) network and a token ring, a no-owner frame (NOF) detecting device has been suggested that stops repeating the frames with an identical source address (SA) and whose number has exceed a threshold (for example, see the Japanese Patent Laid-Open Publication No. H10-327178). As for the Multi-Protocol Label Switching (MPLS), a loop detecting device has been suggested that detects the loop in the label switching path based on the information of the ingress node that is set in the message at the label assignment (for example, see the Japanese Patent Laid-Open Publication No. H11-243416).

However, the conventional art that limits the traffic of the broadcast frame also blocks harmless broadcast frames. As a result, sometimes the communication is virtually blocked. In the conventional art described in the Japanese Patent Laid-Open H9-93282 that monitors the source address and the receiving port, the device itself has to be on the loop. In other words, the device cannot detect the loop caused by incorrect connection of the non-intelligent hub arranged at the end of the network. The conventional art described in the Japanese Patent Laid-Open 2001-197114 that monitors the IP header cannot detect the loop of Non-IP packet, such as the Address Resolution Protocol (ARP) packet, in spite of the fact that the ARP request packet frequently broadcasted is apt to become the loop frame.

The conventional art described in the Japanese Patent Laid-Open H10-327178 that monitors the number of frames by each source MAC address is applied to the FDDI network or the token ring, in other words, cannot be applied to the ring in the Layer 2 network. Besides, the art can detect only the loop frame circulating in the ring, and cannot transfer more frame than a predetermined traffic even if the frame is not the loop frame. As for the conventional art described in the Japanese Patent Laid-Open H11-243416, if the art is applied to the Layer 2 network, the configuration becomes complicated and the cost becomes high to perform the label assignment and the routing control using control frames.

### SUMMARY OF THE INVENTION

It is an object of the present invention to solve at least the problems in the conventional technology.

A loop frame detecting device according to one aspect of the present invention includes a frame receiving and transmitting unit that receives and transmits a Layer 2 frame; and a loop detecting unit that monitors contents of data that constitutes the frame that is received or to be transmitted by the frame receiving and transmitting unit, and determines whether the frame is a loop frame.

A method for detecting a loop frame according to antoher aspect of the present invention includes monitoring contents of data that constitutes a frame, which is a received Layer 2 frame or a Layer 2 frame that is to be transmitted, to determine whether the frame is a loop frame.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a simple schematic of loop frame detection using a loop frame detecting device according to an embodiment of the present invention;

FIG. 2 is a schematic of Ethernet® frame format;

FIG. 3 is a schematic of Virtual LAN (VLAN) tag format;

FIG. 4 is a schematic of MAC address format;

FIG. 5 is a block diagram of the configuration of the loop frame detecting device;

FIG. 6 is a block diagram of the L2 switch (L2SW) with 4 ports according to a first example of the embodiment;

FIG. 7 is a schematic of the items and the values of the L2SW 50 that are set at the initialization;

FIG. 8 is a schematic of status of data stored in the queue 52;

FIG. 9 is a schematic of the contents of the table for filtration 54;

FIG. 10 is a schematic of the contents of the table for detection 4;

FIG. 11 is a flowchart of the details of the reception and transmission of the frame;

FIG. 12 is a flowchart of the details of process performed by the loop detecting unit;

FIG. 13 is a block diagram of a L2SW 130 with 2 ports according to a second example of the embodiment;

FIG. 14 is a schematic of status of data stored in the queue 52;

FIG. 15 is a schematic of the contents of the table for filtration 54;

FIG. 16 is a flowchart of the details of traffic limitation performed by the filter;

FIG. 17 is a schematic of the contents of the table for detection;

FIG. 18 is a flowchart of the details of the reception and transmission of the frame;

FIG. 19 is a schematic of an example of the arrangement of the loop frame detecting device according to the present invention;

FIG. 20 is a schematic for explaining the operation of a common hub;

FIG. 21 is a schematic for explaining the operation of a common bridge;

FIG. 22 is a schematic of the conventional bridge; and

FIG. 23 is a schematic of the conventional frame transfer device.

### DETAILED DESCRIPTION

Exemplary embodiments of a loop frame detecting device and a method for detecting loop frame according to the present invention will be explained in detail with reference to the accompanying drawings.

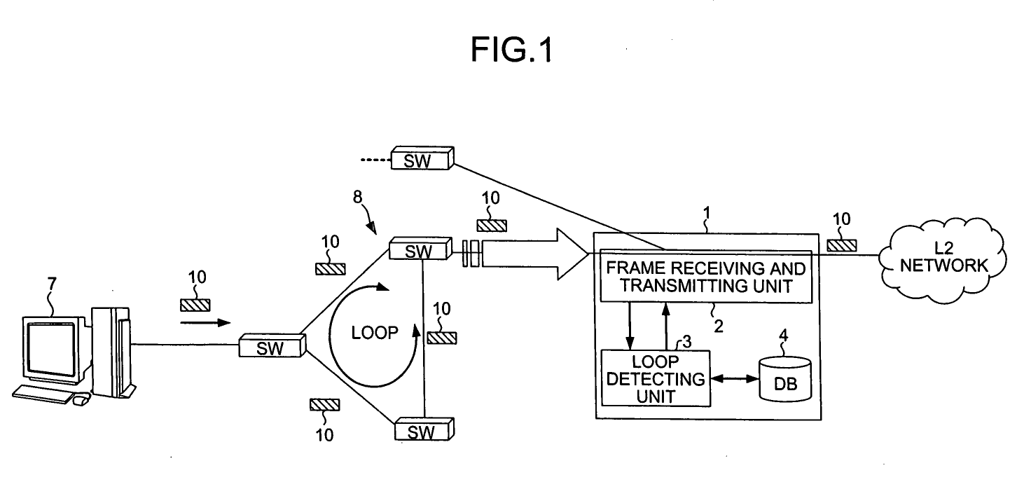

FIG. 1 is a simple schematic of loop frame detection using a loop frame detecting device according to the present invention. A frame is transmitted by a PC 7 or the like, and transferred over a network 8 via a network switch (SW) or the like. The loop frame detecting device 1 monitors the frame data itself or the hash value of the frame data. When detecting the number of an identical frame has exceeded a predetermined threshold, the loop frame detecting device 1 determines the frame as a loop frame and blocks or limits the traffic of the frame.

The loop frame detecting device 1 has a frame receiving and transmitting unit 2, a loop detecting unit 3, and a database 4. The frame receiving and transmitting unit 2 receives a frame data 10. The loop detecting unit 3 detects the loop frame. The loop detecting unit 3 has a comparing means and a determining means (not shown). The comparing means refers to the relevant threshold stored in the database 4 and compares it to the number of the received frame. The determining means determines the frame as the loop frame when detecting the number of an identical frame has exceeded the predetermined threshold. Furthermore, the loop detecting unit 3 has such as a blocking means that instructs the frame receiving and transmitting unit 2 not to transmit (to discard) the received frame data by port closure, and a filtering means that instructs the frame receiving and transmitting unit 2 to limit the traffic. The loop frame detecting device 1 need not necessarily the blocking means, because the limitation of traffic to 0 by the filtering means is virtually equal to the port closure by the blocking means.

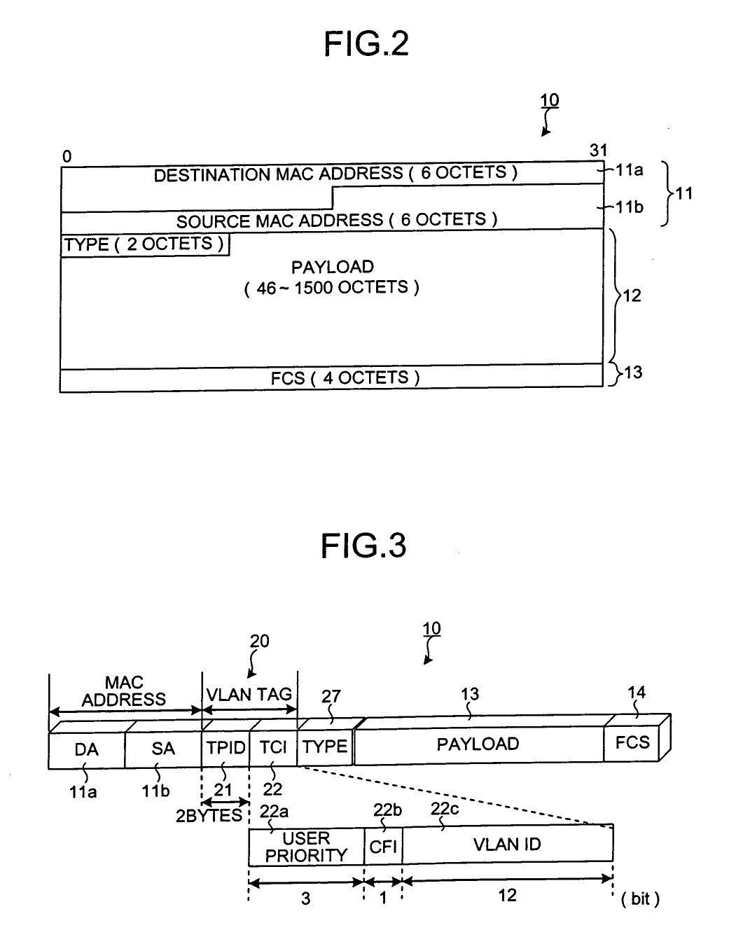

The contents of a Layer 2 frame (i.e. a frame used in a Layer 2 network) will be outlined next. FIG. 2 is a schematic of Ethernet® frame format as an example of typical Layer 2 frame format. All the data transferred over the Layer 2 network (the frame data 10) is put into the Layer 2 frame that is 64 bytes to 1518 bytes long. In FIG. 2, the sign 11 indicates a destination MAC address and a source MAC address, the sign 12 indicates a payload, the sign 13 indicates a Frame Check Sequence (FCS). The destination MAC address 11a and the source MAC address 11b are serially arranged in the beginning of the frame, and both of them are 6 octets long.

FIG. 3 is a schematic of Virtual LAN (VLAN) tag format. A VLAN tag 20 includes a Tag Protocol Identifier (TPID) 21 and a Tag Control Information (TCI) 22. The TCI 22 includes a 3-bit User Priority 22a (usually “0×8100” is set), a 1-bit Canonical Format Identifier (CFI) 22b, and a 12-bit VLAN ID 22c.

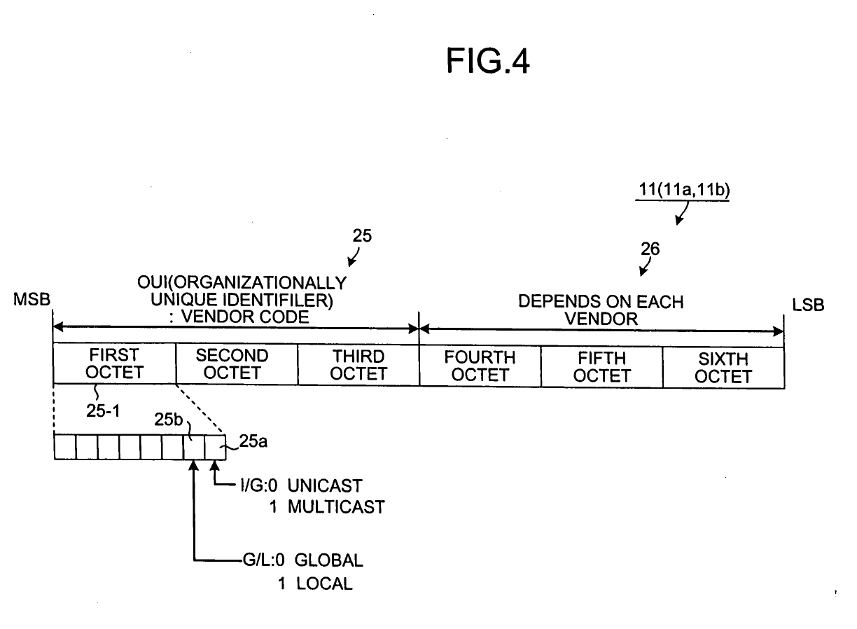

FIG. 4 is a schematic of MAC address format. The MAC address 11 (11a and 11b) is 48 bits (i.e. 6 octets) long, and the first 3 octets are called OUI 25, and the remaining 3 octets 26 are the numbers managed by each vender. The least significant bit of a first octet 25-1 is called the Individual Address/Group Address (I/G) bit 25a, and the next higher-order bit is called the Global/Local (G/L) bit 25b. When “0” is set as the I/G 25a, that indicates unicast, when “1” is set as the I/G 25a, that indicates multicast. The MAC address 11 (11a and 11b) of “FF-FF-FF-FF” indicates broadcast.

A type (type/length) field 27 shown in FIG. 3 is explained next. The value of the type field 27 is taken as the size of data when it is equal to or less than 1500, and is taken as the type of data when it is equal to or more than 1536 (0×0600). The values between 1501 and 1535 are not yet defined. In case of “type”, the type field 27 is set with an ID that indicates the upper Layer protocol by which the data in the payload field 13 is transferred. Examples of the ID are shown below.

IPv4: “0×0800”

IPv6: “0×86DD”

PPPOE: “0×8863” (discovery stage)

PPPOE: “0×8864” (PPP session stage)

IEEE802.3x: “0×8808” (pseudocollision in full-duplex communication)

IEEE802.3ad: “0×8809” (LACP)

A Frame Check Sequence (FCS) 14 in FIG. 3 is a 4-octet field for detecting errors occurred in the frame.

The Layer 2 frame can include the VLAN tag 20 as shown in FIG. 3. The VLAN tag 20 is provided in the IEEE 802.1Q. The IEEE 802.1Q realizes a mechanism to divide a plurality of ports of a bridge (L2 switch) into several groups and to, make each group function as an independent LAN (i.e. a broadcast domain). All the ports of the bridge usually belong to one broadcast domain, and a frame that arrives to one port is forwarded to every other port. However, a plurality of VLANs (virtual LANs) can be set in one bridge that supports VLAN, and ports can be assigned to each VLAN. To realize the VLAN over a plurality of bridges, the VLAN tag 20 is arranged in the Layer 2 frame as a special field for indicating the VLAN attribute. Bridges with VLAN support can exchange the information on which VLAN a frame belongs to, by exchanging the data in the VLAN tag 20. The maximum size of the frame is 1522 bytes, not 1518 bytes, when using the VLAN tag field 20.

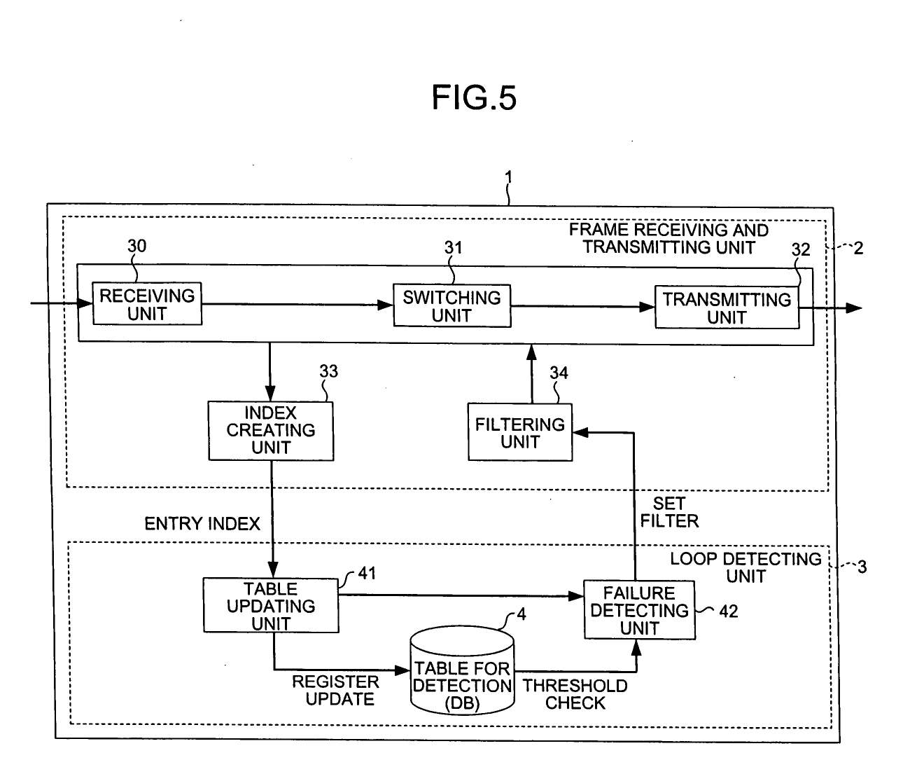

FIG. 5 is a block diagram of the configuration of the loop frame detecting device 1 according to the present invention. The same units as the units shown in FIG. 1 are assigned with the same reference numerals. The loop frame detecting device 1 includes the frame receiving and transmitting unit 2 and the loop detecting unit 3.

The frame receiving and transmitting unit 2 transfers the frame. The transfer of the frame and the detection of the loop frame are performed separately. Basic flow of the process is as follows; reception of the frame by a receiving unit 30, selection of a transmission port by a switching unit 31, transmission of the frame by a transmitting unit 32. The frame receiving and transmitting unit 2 includes an index creating unit 33 that creates an entry index for the loop detection by the loop detecting unit 3, and a filtering unit 34 that filters the frame. The creation of the entry index and the filtration are respectively performed at the time any one of 1. receiving the frame, and 2. transmitting the frame.

The index creating unit 33 sends to the loop detecting unit 3 a frame identifier and information on a receiving port of a target frame for detection. The frame identifier can be 1. the whole frame, or 2. the hash value obtained by compressing the frame. The target frame for detection is not necessarily all frames. For example, all frames that correspond to a specific condition, or all frames other than the frames that correspond to a specific condition, can be set as the target frame for detection. As condition of the target frame for detection, all frames, the presence or absence of the VLAN tag 20, or the like can be set (details will be explained later).

The filtering unit 34 performs the filtration when the loop frame is detected. The filter type of the filtering unit 34 can be 1. to block or limit the traffic of the target frame for filtration, or 2. to block or limit the traffic of all frames other than the target frame for filtration. As condition for determining which frame to filter, loop frames, the presence or absence of the VLAN tag 20, or the like can be set (details will be explained later).

For example, the filtering unit 34 blocks or limits the traffic of the frame determined as the loop frame by the loop detecting unit 3, when the above 1 is set as the filter type and the loop frame is set as the target frame for filtration. The target frame for filtration and the target frame for detection are not necessarily the same. For example, it is possible that the loop detecting unit 3 detects the loop frame from all frames, and the filtering unit 34 blocks the broadcast frame when the loop frame is detected.

The function of the loop detecting unit 3 is explained next. The loop detecting unit 3 counts the number of the received frame by each frame identifier, and determines a frame whose number has exceeded the threshold as the loop frame. The threshold is given as the number of the frame received in a given time. The loop detecting unit 3 includes a table updating unit 41, a failure detecting unit 42, and a table for detection 4 that is identical to the database 4 shown in FIG. 1.

The table updating unit 41 updates the table for detection 4 based on the entry index (i.e. the frame identifier) received from the index creating unit 33 of the frame receiving and transmitting unit 2. When there is an appropriate entry in the table for detection 4, the table updating unit 41 increments a counter, which is for counting the number of the frame, of the entry. When there is not the appropriate entry in the table for detection 4, the table updating unit 41 registers a new entry.

The table for detection (database) 4 includes an entry for each frame identifier. Each entry includes a counter for counting the number of the received frame, and the counter is reset every elapse of predetermined time (i.e. a time interval in which the number of the received frame is counted).

After the update of the table for detection 4 by the table updating unit 41, the failure detecting unit 42 determines whether the target frame for detection is the loop frame or not. More specifically, the failure detecting unit 42 determines the frame as the loop frame when the number of the frame has exceeded the threshold. The number of the frame is counted by the counter of the entry that has the frame identifier of the frame as the index. When detecting the loop frame, the failure detecting unit 42 performs any one of 1. port closure, and 2. notification to the filtering unit 34 of the frame receiving and transmitting unit 2.

According to failure detection by the failure detecting unit 42, the filtering unit 34 instructs the target port for failure prevention to close or to limit the traffic of the frame (by closing some ports, for example). The target port for failure prevention is any one of, or the combination of, the following port or ports; 1. the port of the receiving unit 30 that has received the loop frame; 2. the port of the transmitting unit 32 that is to transmit the loop frame; and 3. all ports of receiving unit 30 and the transmitting unit 32. When the means of failure prevention is not the port closure but the filtration, the filtering unit 34 instructs the target port for failure prevention to filter the frame appropriately according to the location of the filter arranged in the frame receiving and transmitting unit 2. The details of the port closure and the filtration will be explained later.

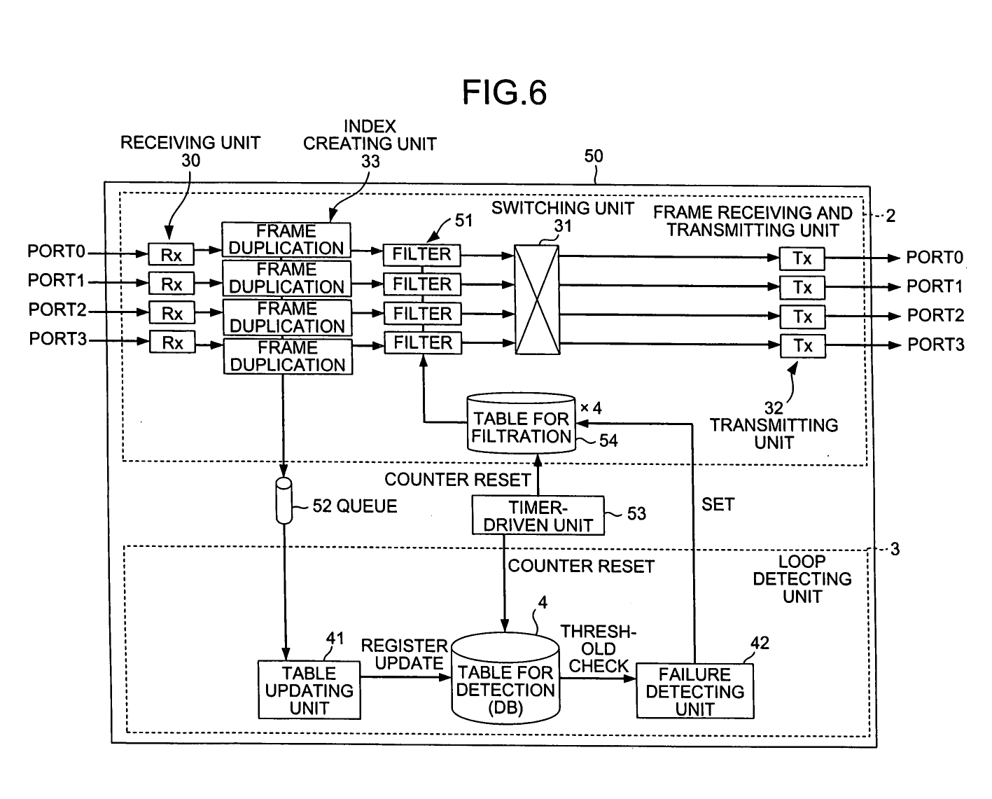

A first example of the embodiment according to the above configuration is explained next. FIG. 6 is a block diagram of the L2 switch (L2SW) with 4 ports. The same units as the above-mentioned units are assigned the same signs. The receiving unit 30 and the transmitting unit 32 of the frame receiving and transmitting unit 2 include respectively 4 ports (Port0 to Port 3). In the frame receiving and transmitting unit 2, 4 systems of signal path are illustrated. The index creating unit 33, a filter 51, and the switching unit (SW) 31 are arranged in sequence in each system that connects the receiving unit 30 to the transmitting unit 32.

The process performed by each unit is explained next. After the initialization, the L2SW 50 performs respectively the reception and transmission of the frame by the frame receiving and transmitting unit 2, and the loop detection by the loop detecting unit 3.

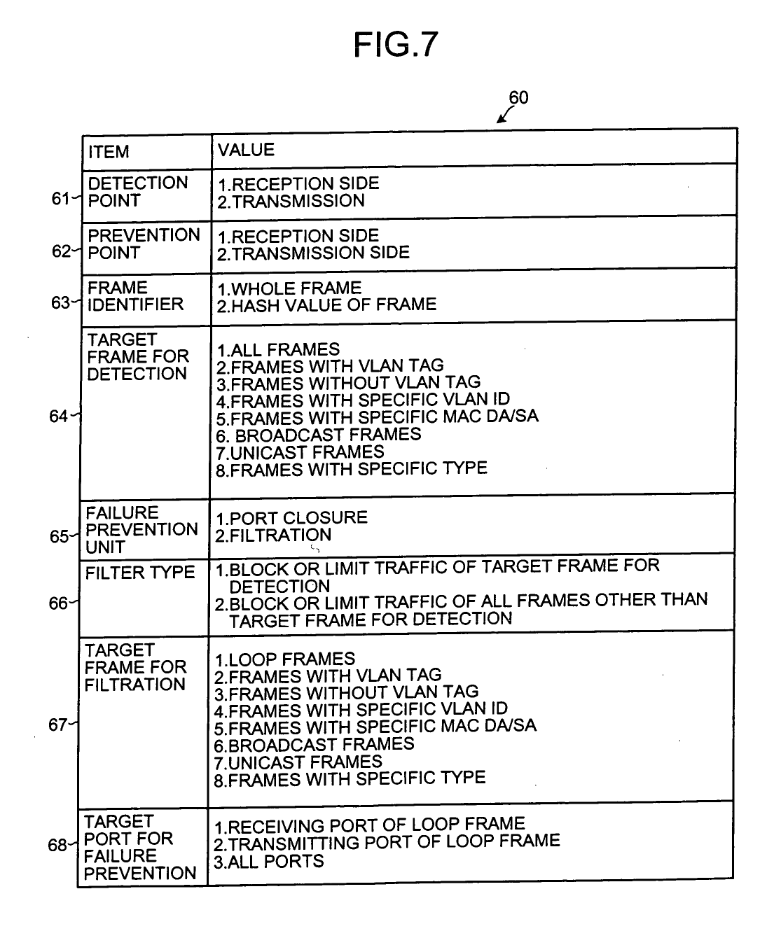

FIG. 7 is a schematic of the items and the values of the L2SW 50 that are set at the initialization. As shown in the list of settings 60, a detection point item 61 and a prevention point item 62 are set with any one of 1. reception side and 2. transmission side. A frame identifier item 63 is set with any one of 1. whole frame and 2. hash value of frame. A target frame for detection item 64 can be set with any one of 1. all frames, 2. frames with the VLAN tag 20, 3. frames without the VLAN tag 20, 4. frames with specific VLAN ID 22c, 5. frames with specific MAC address 11 (DA 11a or SA 11b), 6. broadcast frames, 7. unicast frames, and 8. frames with specific type 27.

A failure prevention unit 65 is set with any one of 1. port closure and 2. filtration (i.e. limitation of the traffic). A filter type item 66 is set with any one of 1. block or limit the traffic of the target frame for filtration, and 2. block or limit the traffic of all frames other than the target frame for filtration. A target frame for filtration item 67 can be set with any one of 1. loop frames, 2. frames with the VLAN tag 20, 3. frames without the VLAN tag 20, 4. frames with specific VLAN ID 22c, 5. frames with specific MAC address 11 (DA 11a or SA 11b), 6. broadcast frames, 7. unicast frames, and 8. frames with specific type 27.

When the filter type item 66 is set with the above 2, the target frame for filtration item 67 is set with the above 4, 5, 7, and 8 to block or limit the traffic of all frames other than the target frame for filtration.

A target port for failure prevention item 68 can be set with any one of 1. port that has received the loop frame, 2. port that is to transmit the loop frame, and 3. all ports.

The initial settings of the L2SW 50 according to the first example are as follows:
1. detection point and prevention point=reception side (i.e. before the SW 31)
2. frame identifier=whole frame
3. target frame for detection=all frames
4. means of failure prevention=filtration
5. filter type=block traffic of target frame for filtration
6. target frame for filtration=broadcast frames
7. target port for failure prevention=receiving port

When the receiving unit 30 of the frame receiving and transmitting unit 2 receives the frame, the index creating unit 33 creates an index for detection by duplicating the frame, and push the index into a queue 52 (see FIG. 6) with the number of the receiving port.

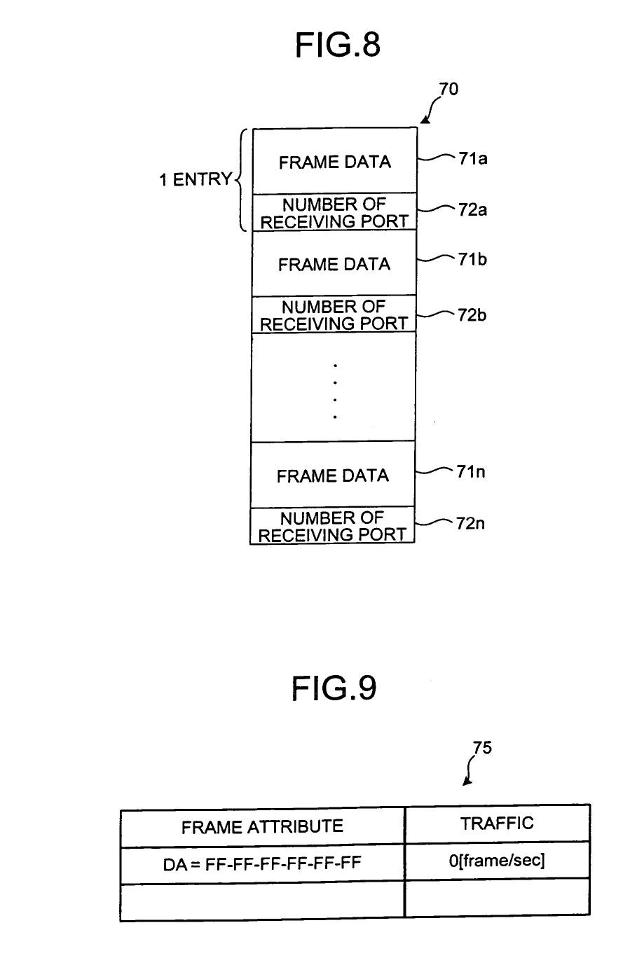

FIG. 8 is a schematic of status of data stored in the queue 52. In a buffer 70 of the queue 52, a frame data 71 and a number of the receiving port 72 are stored for each entry. The queue 52 is a FIFO buffer. The number of the entry is limited to n (71a to 71n and 72a to 72n) because the buffer size is limited.

When there is no free space in the queue 52, however, the received frame is filtered as-is without being added to the queue 52 by the index creating unit 33. When the detection process is slower than the transfer process, the loop detecting unit 3 may be unable to process all of the received frames because the queue 52 overflows (in other words, because the queue 52 is full). But it does not cause any problem.

The filter 51 of the frame receiving and transmitting unit 2 filters the received frame. Each port is provided with a table for filtration 54 (see FIG. 6). In FIG. 6, there are 4 tables for filtration 54 that are referred to by the filter 51 in checking the received frame with the entry of the table one by one.

FIG. 9 is a schematic of the contents of the table for filtration 54 used for filter control. According to the settings of conditions for filtration 75 shown in FIG. 9, when there is an entry whose DA is “FF-FF-FF-FF” (i.e. broadcast address) and traffic is “0” in the table for filtration 54, the filter 51 compares the destination MAC address of the received frame to “FF-FF-FF-FF”. When the addresses conform, the filter 51 discards the frame to limit the traffic to “0”. On the other hand, when the addresses do not conform, the frame is subjected to the bridging (switching) process by the SW 31 and sent to the transmission port of the transmitting unit 32.

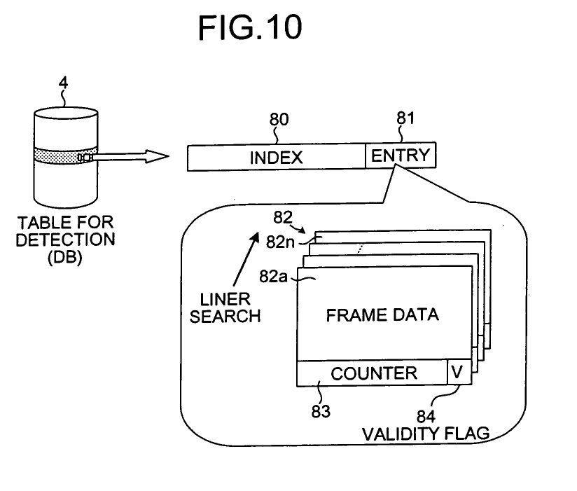

The table updating unit 41 of the loop detecting unit 3 receives the frame data from the frame receiving and transmitting unit 2 via the queue 52. FIG. 10 is a schematic of the contents of the table for detection 4. The table updating unit 41 hashes the received frame data using the Cyclic Redundancy Check (CRC) 16, and searches the table for detection 4 by comparing the hash value to an index 80. An entry 81 has depth. Each frame data 82 (82a to 82n) is provided with a counter 83. The table updating unit 41 specifies the counter 83 to be incremented by comparing the frame data 82 corresponds to each counter 83 to the received frame data, and increments the appropriate counter 83. When there is no appropriate entry, the table updating unit 41 registers a new entry in the table for detection 4. When there is no free space in the table for detection 4, the table updating unit 41 discards the frame data popped from the queue 52.

The counter 83 in the table for detection 4 is reset by a timer-driven unit 53 every elapse of predetermined time (i.e. a time interval in which the number of the received frame is counted) measured by the timer-driven unit 53. The aging (i.e. process of turning off a validity flag 84) of each entry 81 is also performed every elapse of the predetermined time.

The failure detecting unit 42 of the loop detecting unit 3 determines a frame as the loop frame when the value of the counter 83 of the frame, which has been incremented at the update of the table, has exceeded the predetermined threshold. Under the settings shown in FIG. 9, the failure detecting unit 42 sets “DA=FF-FF-FF-FF (broadcast address)” and “traffic=0” to the table for filtration 54, which is provided for each port, of the receiving port of the frame.

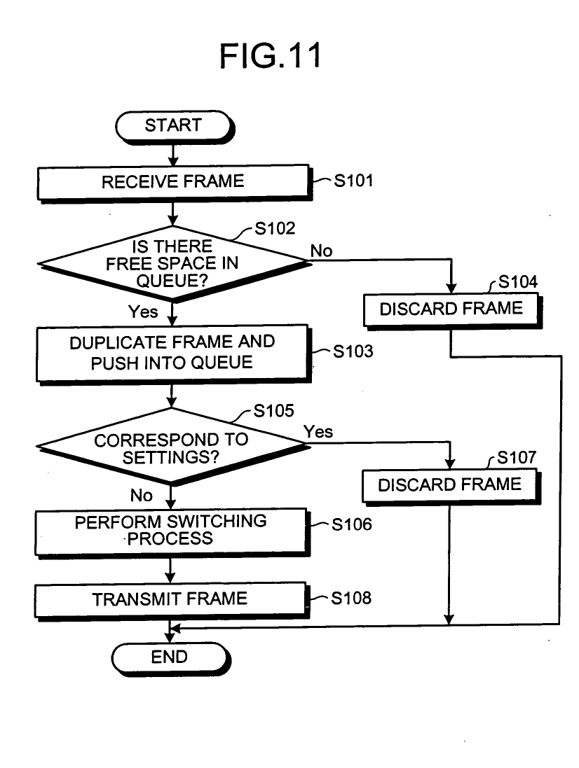

The flow of processes according to the first example is explained next. FIG. 11 is a flowchart of the details of the reception and transmission of the frame. When the receiving unit 30 of the frame receiving and transmitting unit 2 receives the frame (Step S101), the index creating unit 33 determines whether there is any free space in the queue 52 or not (Step S102). When there is free space in the queue 52 (Step S102: Yes), the index creating unit 33 duplicates the frame and pushes the duplicated frame into the queue 52 (Step S103). As a result, the frame is sent to the loop detecting unit 3. On the other hand, when there is no free space in the queue 52 (Step S102: No), the index creating unit 33 discards the received frame (Step S104), then the process ends.

After Step S103, the filter 51 performs filter check (Step S105). More specifically, the filter 51 checks the received frame with the settings in the table for filtration 54. When the frame corresponds to the settings (Step S105: Yes), the filter 51 discards the frame (Step S107), then the process ends. When the frame does not correspond to the settings (Step S105: No), the SW31 sends the frame to the port of the transmitting unit 32 by the switching process (Step S106), and the transmitting unit 32 transmits the frame (Step S108), then the process ends. According to the settings of the first example, all frames received by the receiving unit 30 are discarded in the frame discarding process at Step S104. On the other hand, in the frame discarding process at Step 5107, all of broadcast frames received by the receiving unit 30 are discarded.

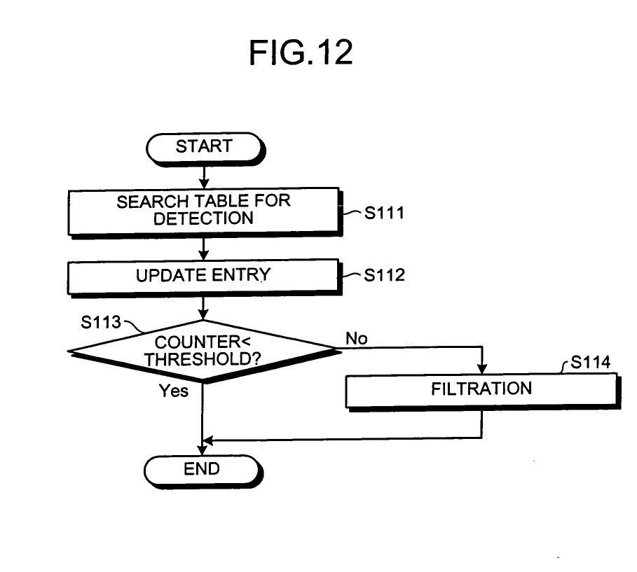

FIG. 12 is a flowchart of the details of process performed by the loop detecting unit 3. The process shown in FIG. 12 is performed in parallel with the process shown in FIG. 11. The table updating unit 41 receives the frame data from the frame receiving and transmitting unit 2 via the queue 52, searches the table for detection 4 (Step S111), and updates the entry 81 (Step S112). More specifically, when the frame is a new frame, the table updating unit 41 adds a new entry 81 to the table for detection 4. When there is any appropriate entry 81 in the table for detection 4, the table updating unit 41 updates the counter 83 of the appropriate entry 81. When there is no free space in the table for detection 4, the table updating unit 41 discards the frame data popped from the queue 52.

The failure detecting unit 42 compares the incremented counter 83 to the predetermined threshold (Step S113). When the value of the counter 83 is less than the threshold (Step S113: Yes), the failure detecting unit 42 does nothing and the process ends. When the value of the counter 83 is equal to or more than the threshold (Step S113: No), the failure detecting unit 42 determines the frame as the loop frame, and instructs the filter 51 to filter the frame according to the settings in the table for filtration 54 (see FIG. 9) (Step S114). Under the settings shown in FIG. 9, the filter 51 discards the received frame (as a result, the traffic becomes 0) when the destination address of the frame is the broadcast address.

According to the first example explained above, the loop frame detecting device 1 monitors all data that constitutes the frame (i.e. the whole frame) and blocks the broadcast frame at the receiving port. The device can detect the loop frame without any limitation due to the location of the device in the network. As a result, the spreading of the failure occurred in the network can be minimized. Furthermore, necessary frames are not lost because the device can block only the loop frame by discarding them.

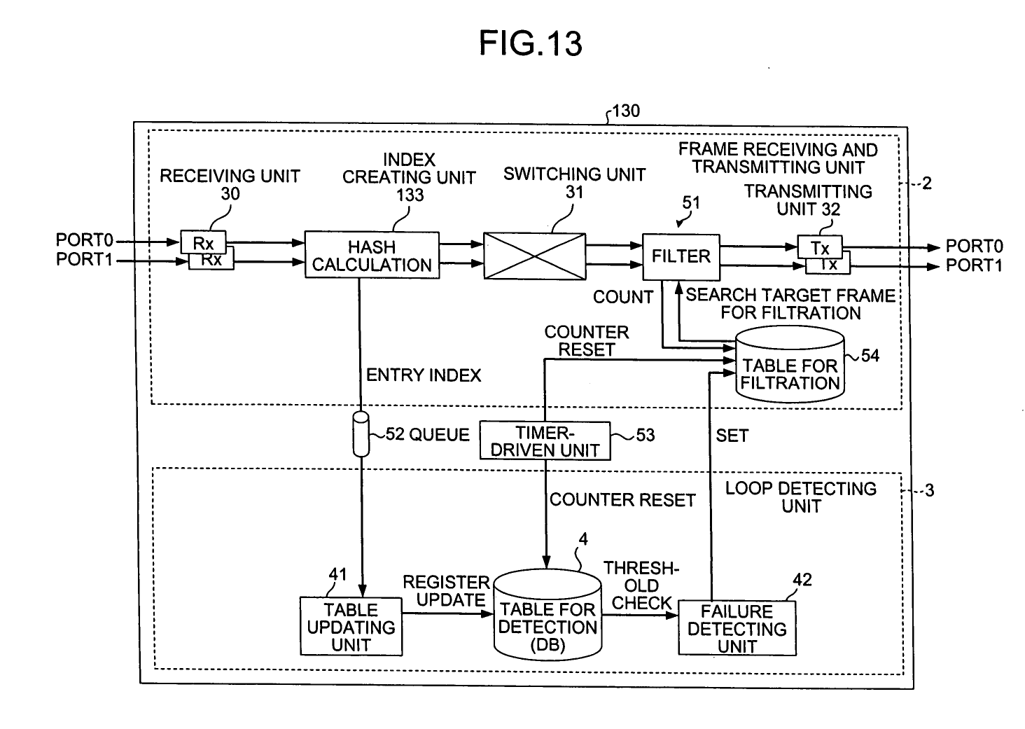

A second example of the embodiment is explained next. FIG. 13 is a block diagram of a L2SW 130 with 2 ports. According to the second example, an index creating unit 133 calculates the hash value of the frame data, and creates the entry index using the hash value. In FIG. 13, the same units as the above-mentioned units are assigned the same signs. The receiving unit 30 and the transmitting unit 32 of the frame receiving and transmitting unit 2 include 2 ports (Port0 and Port 1). In the frame receiving and transmitting unit 2, 2 systems of signal path are illustrated. The index creating unit 133, the switching unit (SW) 31, and the filter 51 are arranged in sequence in each system that connects the receiving unit 30 to the transmitting unit 32.

The process performed by each unit is explained next. After the initialization, the L2SW 130 performs respectively the reception and transmission of the frame by the frame receiving and transmitting unit 2, and the loop frame detection by the loop detecting unit 3.

The initial settings of the L2SW 130 according to the second example are as follows:
1. detection point and prevention point=transmission side (i.e. after the SW 31)
2. frame identifier=hash value
3. target frame for detection=all frames
4. means of failure prevention=filtration
5. filter type=limit traffic of target frame for filtration (1 frame per second)
6. target frame for filtration=loop frames
7. target port for failure prevention=all ports.

When the receiving unit 30 of the frame receiving and transmitting unit 2 receives the frame, the index creating unit 133 creates an index for detection by calculating the hash value of the frame using such as the CRC 32, and push the hash value into the queue 52 with the number of the receiving port.

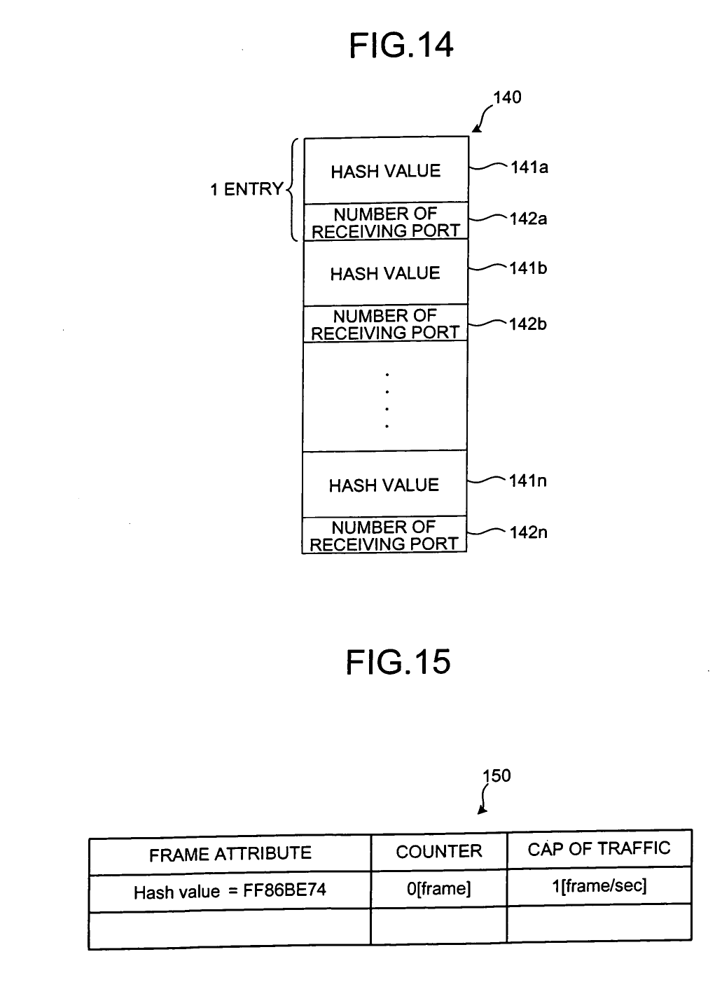

FIG. 14 is a schematic of status of data stored in the queue 52. In a buffer 140 of the queue 52, a hash value 141 and a number of the receiving port 142 are stored for each entry. The queue 52 is a FIFO buffer. The number of the entry is limited to n (141a to 141n and 142a to 142n) because the buffer size is limited.

When there is no free space in the queue 52, however, the received frame is filtered as-is without being added to the queue 52. In the second example, the bridging process is not involved because the frame is transferred between two ports.

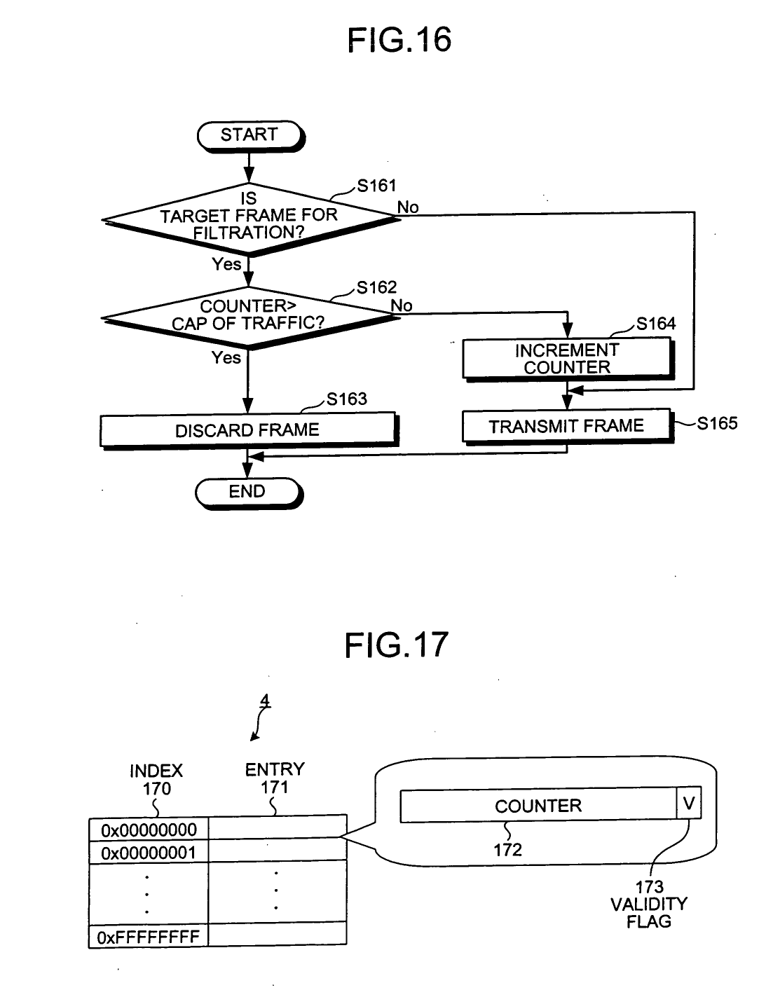

The filter 51 of the frame receiving and transmitting unit 2 filters the frame to be transmitted. FIG. 15 is a schematic of the contents of the table for filtration 54 used for filter control. The settings of conditions for filtration 150 shown in FIG. 15 are commonly used on all ports. The filter 51 compares the hash value of the received frame to the hash value set in the table for filtration 54 (in this case, “FF86BE74”). When the values do not conform, the filter 51 compares the former hash value to the next entry, and when there is no appropriate entry to the end, the filter 51 sends the frame to the transmission port of the transmitting unit 32. On the other hand, the hash value of the received frame conforms to the hash value of the entry shown in FIG. 15 (“FF86BE74”), the filter 51 limits the traffic of the frame to be transmitted according to the procedure shown in the following FIG. 16. Under the settings shown in FIG. 15, the frames to be transmitted are limited to 1 frame per second. The value of the counter is the actual traffic of the transmitted frames. The value is counted by the filter 51 shown in FIG. 13, and is stored as needed in the field of counter of the table for filtration 54 shown in FIG. 15.

FIG. 16 is a flowchart of the details of traffic limitation performed by the filter 51. The filter 51 determines whether the received frame is the target frame for filtration or not (Step S161). When the received frame is the target frame for filtration (Step S161: Yes), the filter 51 compares the value of the counter in the table for filtration 54 (see FIG. 15) to the predetermined cap of the traffic (Step S162). When the received frame is not the target frame for filtration (Step S161: No), the transmitting unit 32 transmits the frame (Step S165), then the process ends.

On the other hand, when the value of the counter is more than the cap of the traffic (Step S162: Yes), the filter 51 discards the frame (Step S163), then the process ends. When the value of the counter is not more than the cap of the traffic (Step S162: No), the filter 51 increments the counter (Step S164) and the transmitting unit 32 transmits the frame (Step S165), then the process ends. The counter is reset by the timer-driven unit 53 (see FIG. 13) every elapse of predetermined time (i.e. a time interval in which the traffic is measured, for example, every second).

The loop detecting unit 3 receives the hash value from the frame receiving and transmitting unit 2 via the queue 52. FIG. 17 is a schematic of the contents of the table for detection 4. The table updating unit 41 searches the table for detection 4 by comparing the received hash value to an index 170. The hash values of the index 170 shown in FIG. 17 are calculated using the CRC 32. When a validity flag 173 of an entry 171 that corresponds to the received hash value is true, the table updating unit 41 increments a counter 172. On the other hand, when there is no appropriate entry 171 or when the validity flag 173 of the appropriate entry 171 is not true, the table updating unit 41 registers a new entry 171 in the table for detection 4. The counter 172 in the table for detection 4 is reset by the timer-driven unit 53 every elapse of predetermined time (i.e. a time interval in which the number of the received frame is counted). The aging (i.e. process of turning off (in other words, setting “false” to) the validity flag 173) of each entry 171 is also performed every elapse of the predetermined time.

The failure detecting unit 42 determines a frame as the loop frame when the value of the counter 172 of the frame, which has been incremented at the update of the table, has exceeded the predetermined threshold. According to the second example, the failure detecting unit 42 adds to the table for filtration 54 the entry shown in FIG. 15 that includes “hash value=FF86BE74” as the frame attribute and “1 frame per second” as the cap of the traffic.

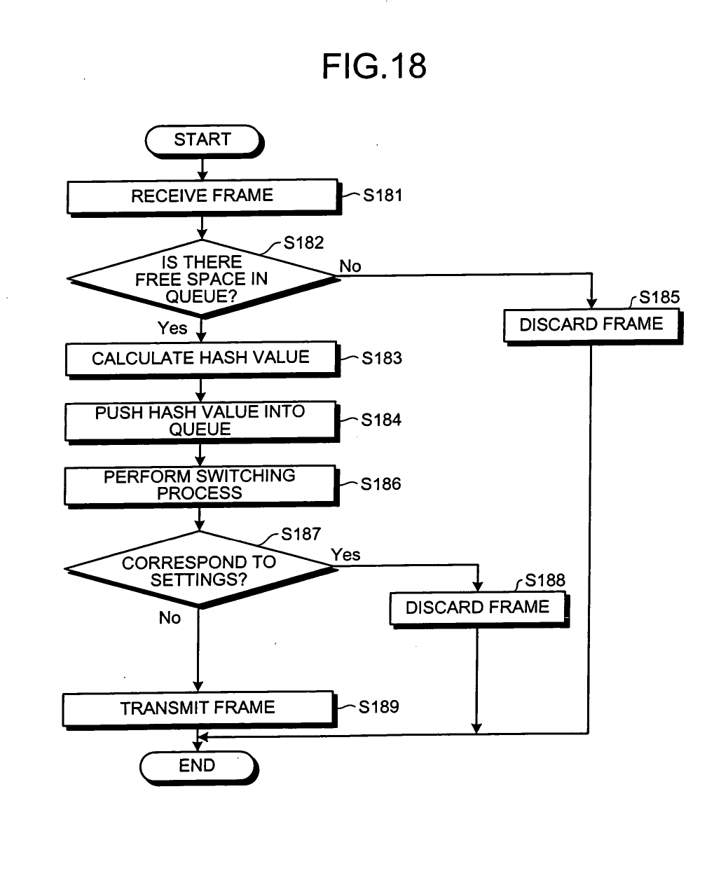

The flow of processes according to the second example is explained next. FIG. 18 is a flowchart of a process procedure for the reception and transmission of the frame. When the receiving unit 30 of the frame receiving and transmitting unit 2 receives the frame (Step S181), the index creating unit 133 determines whether there is any free space in the queue 52 or not (Step S182). When there is free space in the queue 52 (Step S182: Yes), the index creating unit 133 calculates the hash value of the frame (Step S183) and pushes the hash value into the queue 52 (Step S184). As a result, the hash value of the received frame is sent to the loop detecting unit 3. On the other hand, when there is no free space in the queue 52 (Step S182: No), the index creating unit 133 discards the received frame (Step S185), then the process ends.

After Step S184, the SW31 performs the switching process (Step S186) and the filter 51 performs filter check (Step S187). More specifically, the filter 51 checks the received frame with the settings in the table for filtration 54. When the frame corresponds to the settings (Step S187: Yes), the filter 51 discards the frame (Step S188), then the process ends. When the frame does not correspond to the settings (Step S187: No), the frame is sent to and transmitted from the port of the transmitting unit 32 (Step S189), then the process ends. According to the settings of the second example, all frames received by the receiving unit 30 are discarded in the frame discarding process at Step S185. On the other hand, in the frame discarding process at Step S188, the loop frames received by the receiving unit 30 are discarded so that the traffic of the loop frame does not exceed 1 frame per second.

The process performed by the loop detecting unit 3 is the same irrespective of the settings. Thus, the process performed by the loop detecting unit 3 according to the second example is similar to that of the first example (see FIG. 12).

According to the second example explained above, the loop frame detecting device 1 monitors the frame, detects the loop frame using the hash value of the frame, and limits the traffic of the frame by the filtration at all ports when detecting the loop frame. The device can quickly search the table due to the use of the hash value. The device can detect the loop frame without any limitation due to the location of the device in the network. As a result, the spreading of the failure occurred in the network can be minimized. Furthermore, necessary frames are not lost because the device not only blocks the frame completely, but also let the frame go through the device by traffic limitation (in other words, because the device can respond flexibly to the failures occurred in the network).

A third example of the embodiment is explained next. The configuration of the loop frame detecting device 1 according to the third example is similar to that of the second example (see FIG. 13). The settings are also similar to those of the second example, except that the target frame for detection (above-mentioned 3) is the frames without the VLAN tag 20. In the third example, the index creating unit 133 checks whether the frame data includes the VLAN tag 20 or not, before the creation of the entry index explained in the second example. When the frame is without the VLAN tag 20, the index creating unit 133 calculates the entry index (i.e. the hash value). When the frame is with the VLAN tag 20, the index creating unit 133 moves on to the process of the next frame, without calculating the entry index. Accordingly, only the frames without the VLAN tag 20 become the target frame for detection. As a result, the frames with the VLAN tag 20, which are set with high priority, can go through the device even if they are the loop frames.

A fourth example of the embodiment is explained next. The configuration of the loop frame detecting device 1 according to the fourth example is similar to that of the second example (see FIG. 13). The settings are also similar to those of the second example, except that the means of failure prevention (above-mentioned 4) is the port closure, and the target port for failure prevention (above-mentioned 7) is the receiving port. In the fourth example, when detecting the loop frame, the loop frame detecting device 1 controls closure of the receiving port of the frame. As a result, the loop frame detecting device 1 according to the fourth example does not need the filter 51 used in the second example. The configuration of the device can be simplified because the device blocks (discards) the loop frame without the filter 51.

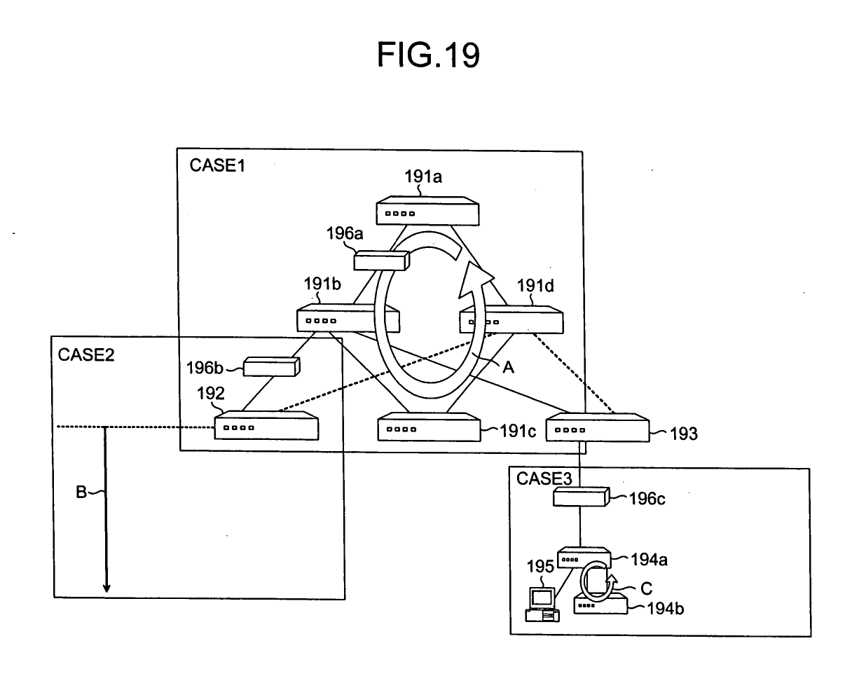

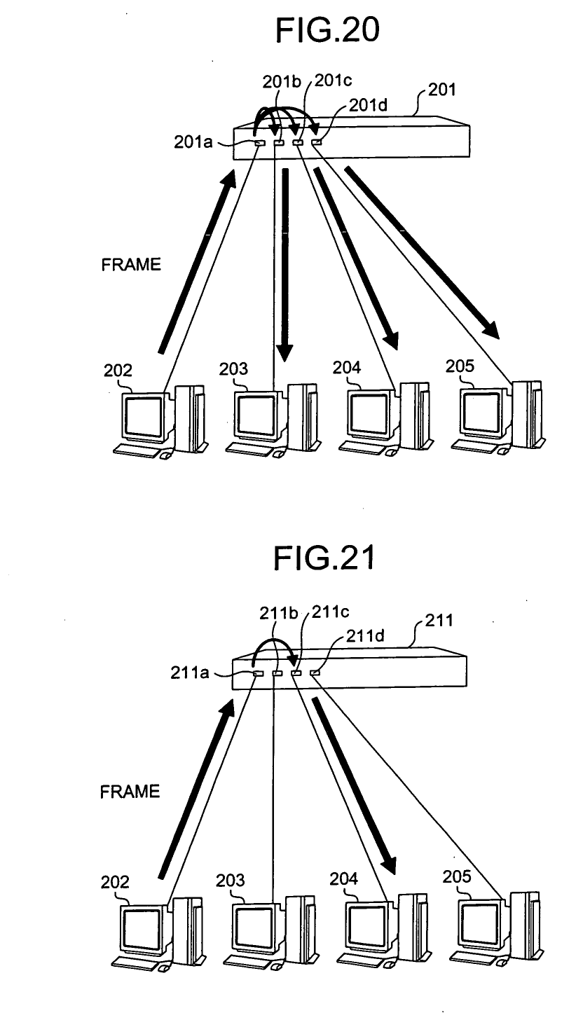

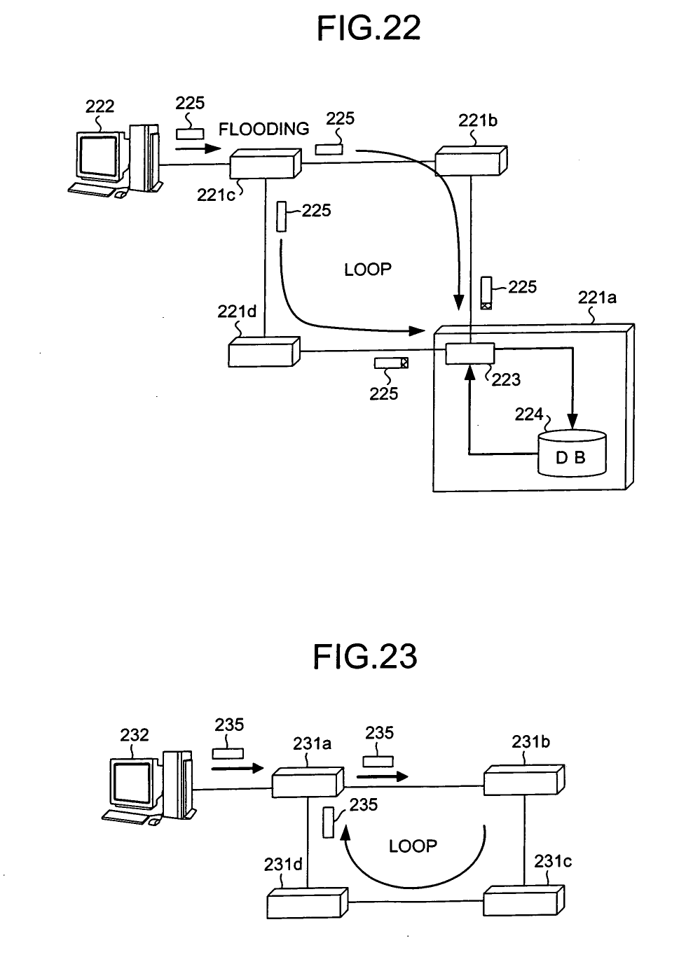

Examples of the arrangement of the loop frame detecting device in the network are explained next. FIG. 19 is a schematic of an example of the arrangement of the loop frame detecting device. A first case: a loop frame A circulating through the SWs 191a to 191d in a plurality of network switches (SW) can be detected by the loop frame detecting device 196a that is arranged in the loop of the loop frame A.

A second case: the loop frame detecting device 196b, that is arranged between the loop of the loop frame A and a SW 192 that is arranged out of the loop, can prevent the spreading of the failure to a downstream network B connected to the SW 192. When detecting the loop frame A out of its loop, the loop frame detecting device 196b blocks the loop frame A between the loop and the downstream network to prevent the spreading of the failure.

A third case: When a loop frame C is generated between a SW 194a and a SW 194b that are arranged in an end network connected to a SW 193, the loop frame detecting device 196c arranged between the SW 193 and both of the SW 194a and 194b can prevent the spreading of the failure to the entire upstream network by blocking the loop frame C generated in the end network. The sign 95 indicates a personal computer (PC) 95 arranged at the enc of the network. In the third case, it is effective to apply port closure according to the fourth example explained above.

The loop frame detecting device according to the embodiment explained above functions as the network switch or the intermediary device because it has the switch. When the device does not have the switch, it functions as a loop frame detecting device that detects and discards the loop frame all by itself.

The method for detecting loop frame explained in the present embodiment can be realized by executing a program that is prepared beforehand by computers, such as a personal computer and a workstation. The program is recorded on a computer-readable medium such as a hard disk, a flexible disk, a CD-ROM, a MO, and a DVD, and is read and executed by the computer. The program can be a transmission medium that can be distributed via a network such as the Internet.

The loop frame detecting device and the method for detecting loop frame according to the present invention can detect the loop frame in the Layer 2 network, even if the device is not in its loop, by referring to the contents of data that constitutes the frame received by the device. Furthermore, the device and the method can prevent the loop failure itself or the spreading of the loop failure by blocking or filtering the detected loop frame, and minimize the damage due to the failure.

According to the present invention, it is possible to prevent a loop failure or to minimize a damage caused by the loop failure.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A loop frame detecting device comprising:
a frame receiving and transmitting unit that receives and transmits a Layer 2 frame; and
a loop detecting unit that monitors contents of data that constitutes the frame that is received or to be transmitted by the frame receiving and transmitting unit, and determines whether the frame is a loop frame.

2. The loop frame detecting device according to claim 1, wherein the loop detecting unit includes
a comparing unit that compares the contents of the data with contents of predetermined reference data; and
a determining unit that determines a frame that corresponds with the contents of the predetermined reference data as the loop frame when traffic of the frame exceeds a predetermined threshold.

3. The loop frame detecting device according to claim 1, further comprising a calculating unit that calculates a hash value of the data, wherein
the loop detecting unit includes
a comparing unit that compares the hash value with a predetermined reference value; and
a determining unit that determines the frame of which the hash value corresponds with the predetermined reference value as the loop frame when traffic of the frame exceeds a predetermined threshold.

4. The loop frame detecting device according to claim 1, wherein
the frame receiving and transmitting unit includes
a reception port that performs reception of the frame; and
a transmission port that performs transmission of the frame, and
the loop detecting unit monitors the frame received by the reception port.

5. The loop frame detecting device according to claim 1, wherein
the frame receiving and transmitting unit includes
a reception port that performs reception of the frame; and
a transmission port that performs transmission of the frame, and
the loop detecting unit monitors the frame to be transmitted by the transmission port.

6. The loop frame detecting device according to claim 4, further comprising:
a port closing unit that blocks the frame by closing any one of the reception port from which the frame determined as the loop frame is received, the transmission port from which the frame determined as the loop frame is to be transmitted, and all of the reception port and the transmission port.

7. The loop frame detecting device according to claim 5, further comprising:
a port closing unit that blocks the frame by closing any one of the reception port from which the frame determined as the loop frame is received, the transmission port from which the frame determined as the loop frame is to be transmitted, and all of the reception port and the transmission port.

8. The loop frame detecting device according to claim 4, further comprising:
a filtering unit that limits and blocks the traffic by performing filtration for a specific frame at any one of the reception port from which the frame determined as the loop frame is received, the transmission port from which the frame determined as the loop frame is to be transmitted, and all of the reception port and the transmission port.

9. The loop frame detecting device according to claim 5, further comprising:
a filtering unit that limits and blocks the traffic by performing filtration for a specific frame at any one of the reception port from which the frame determined as the loop frame is received, the transmission port from which the frame determined as the loop frame is to be transmitted, and all of the reception port and the transmission port.

10. The loop frame detecting device according to claim 1, wherein the loop detecting unit monitors or does not monitor the frame based on whether the frame includes a VLAN tag.

11. The loop frame detecting device according to claim 1, wherein the loop detecting unit monitors or does not monitor the frame based on whether the frame includes a specific VLAN ID.

12. The loop frame detecting device according to claim 1, wherein the loop detecting unit monitors or does not monitor the frame based on whether the frame includes any one of a specific destination MAC address and a specific source MAC address.

13. The loop frame detecting device according to claim 1, wherein the loop detecting unit monitors the frame that is a broadcast frame.

14. The loop frame detecting device according to claim 1, wherein the loop detecting unit monitors or does not monitor the frame that is a unicast frame.

15. The loop frame detecting device according to claim 1, wherein the loop detecting unit monitors or does not monitor the frame based on whether the frame includes a specific type-value.

16. The loop frame detecting device according to claim 8, wherein the filtering unit filters only the loop frame.

17. The loop frame detecting device according to claim 9, wherein the filtering unit filters only the loop frame.

18. The loop frame detecting device according to claim 8, wherein the filtering unit filters any one of the frame with a VLAN tag and the frame without the VLAN tag.

19. The loop frame detecting device according to claim 9, wherein the filtering unit filters any one of the frame with a VLAN tag and the frame without the VLAN tag.

20. The loop frame detecting device according to claim 8, wherein the filtering unit filters or does not filter the frame with a specific VLAN ID.

21. The loop frame detecting device according to claim 9, wherein the filtering unit filters or does not filter the frame with a specific VLAN ID.

22. The loop frame detecting device according to claim 8, wherein the filtering unit filters or does not filter the frame with any one of a specific destination MAC address and a specific source MAC address.

23. The loop frame detecting device according to claim 9, wherein the filtering unit filters or does not filter the frame with any one of a specific destination MAC address and a specific source MAC address.

24. The loop frame detecting device according to claim 8, wherein the filtering unit filters the frame that is a broadcast frame.

25. The loop frame detecting device according to claim 9, wherein the filtering unit filters the frame that is a broadcast frame.

26. The loop frame detecting device according to claim 8, wherein the filtering unit filters or does not filter the frame that is an unicast frame.

27. The loop frame detecting device according to claim 9, wherein the filtering unit filters or does not filter the frame that is an unicast frame.

28. The loop frame detecting device according to claim 8, wherein the filtering unit filters or does not filter the frame with a specific value of type.

29. The loop frame detecting device according to claim 9, wherein the filtering unit filters or does not filter the frame with a specific value of type.

30. The loop frame detecting device according to claim 8, wherein the filtering unit filters all contents of the data in the frame.

31. The loop frame detecting device according to claim 9, wherein the filtering unit filters all contents of the data in the frame.

32. The loop frame detecting device according to claim 1, wherein the frame receiving and transmitting unit includes a switch for switching a transmission port from which the frame received by the reception port is to be transmitted.

33. A method for detecting a loop frame comprising:
monitoring contents of data that constitutes a frame, which is a received Layer 2 frame or a Layer 2 frame that is to be transmitted, to determine whether the frame is a loop frame.

34. The method for detecting a loop frame according to claim 33, wherein the determining includes
comparing the contents of the data with contents of predetermined reference data; and
determining a frame that corresponds with the contents of the predetermined reference data as the loop frame when traffic of the frame exceeds a predetermined threshold.
